(19) United States
(12) Patent Application Publication
(10) Pub. No.: US 2016/0202451 A1
(43) Pub. Date: Jul. 14, 2016

(54) NON-PLANAR FOCAL SURFACE LENS ASSEMBLY

(71) Applicant: Microsoft Technology Licensing, LLC, Redmond, WA (US)

(72) Inventors: Brian Kevin Guenter, Redmond, WA (US); Neel Suresh Joshi, Redmond, WA (US); Changyin Zhou, Newark, CA (US)

(73) Assignee: Microsoft Technology Licensing, LLC, Redmond, WA (US)

(21) Appl. No.: 15/079,361

(22) Filed: Mar. 24, 2016

Related U.S. Application Data
(62) Division of application No. 13/172,168, filed on Jun. 29, 2011.

(51) Int. Cl. G02B 9/12; H04N 5/225; G02B 27/00

(52) U.S. Cl. CPC G02B 9/12; G02B 27/0025; H04N 5/2253; H04N 5/2254

(57) ABSTRACT

A lens assembly includes a plurality of component lens elements, and a fiber optic face plate having a back surface and a non-planar front surface. The plurality of component lens elements are configured to direct a focused image onto the non-planar front surface of the fiber optic face plate, and the fiber optic face plate is configured to transmit the focused image through the back surface.

### CROSS-REFERENCE TO RELATED APPLICATION

This patent application is a divisional of Ser. No. 13/172,168 filed Jun. 29, 2011, entitled “NON-PLANAR FOCAL SURFACE LENS ASSEMBLY,” which is incorporated herein by reference.

### BACKGROUND

A fast camera lens (i.e., a lens with a small f number) is desirable because it allows pictures to be taken under low light with shorter shutter speeds, resulting in less motion blur. It is difficult to design fast lenses that make sharp pictures because lens aberrations increase very rapidly as the f number decreases.

### SUMMARY

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

Embodiments disclosed herein address the problem of designing fast camera lenses with minimal lens aberrations. If a lens system is designed so that it focuses on a non-planar image surface, lens aberrations are significantly reduced. One embodiment interposes a coherent fiber optic bundle between the lens elements and the imaging plane of an image sensor. The surface of the bundle that faces the lens is ground in a non-planar shape that reduces lens aberrations. The non-planar focal surface shape (i.e., the shape of the surface of the bundle that faces the lens) and the lens elements are simultaneously optimized to reduce lens aberrations and produce the sharpest possible image.

One embodiment is directed to a lens assembly, which includes a plurality of component lens elements, and a fiber optic face plate having a back surface and a non-planar front surface. The plurality of component lens elements are configured to direct a focused image onto the non-planar front surface of the fiber optic face plate, and the fiber optic face plate is configured to transmit the focused image through the back surface.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated, as they become better understood by reference to the following detailed description. The elements of the drawings are not necessarily to scale relative to each other. Like reference numerals designate corresponding similar parts.

FIG. 1 is a diagram illustrating a lens and image sensor assembly according to one embodiment.

FIG. 2 is a diagram illustrating a lens and image sensor assembly according to another embodiment.

### DETAILED DESCRIPTION

In the following Detailed Description, reference is made to the accompanying drawings, which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

It is to be understood that features of the various exemplary embodiments described herein may be combined with each other, unless specifically noted otherwise.

Embodiments disclosed herein address the problem of designing fast camera lenses with minimal lens aberrations. If a lens system is designed so that it focuses on a non-planar image surface, lens aberrations are significantly reduced. One embodiment interposes a coherent fiber optic bundle between the lens elements and the imaging plane of an image sensor. The surface of the bundle that faces the lens is ground in a non-planar shape that reduces lens aberrations. The non-planar focal surface shape (i.e., the shape of the surface of the bundle that faces the lens) and the lens elements are simultaneously optimized to reduce lens aberrations and produce the sharpest possible image. This allows for higher sharpness lenses at lower f numbers. One embodiment is directed to an interchangeable lens system in which each lens contains not only the optical lens elements, but also the image sensor, permanently bonded to the back face of the coherent fiber optic bundle. The focal plane surface according to one embodiment becomes an additional free parameter, which is not optimized in conventional lens designs. In one embodiment, conventional optimization techniques can be used to simultaneously optimize both the lens elements and the shape of the focal plane.

One embodiment is directed to a compact imaging lens system that has three or less component lens elements and a coherent fiber optic bundle with a non-planar surface, and is particularly suitable for use in a portable imaging device. In one embodiment, the compact imaging lens system can be easily manufactured at low costs while offering a high level of optical performance.

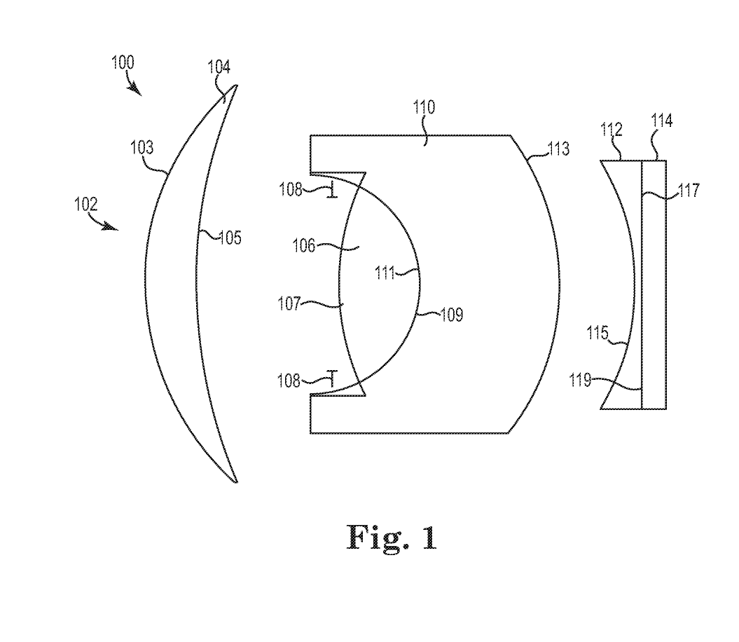

FIG. 1 is a diagram illustrating a lens and image sensor assembly 100 according to one embodiment. Assembly 100 includes a lens assembly 102 and an image sensor 114. Lens assembly 102 includes a first component lens element 104, a second component lens element 106, a third component lens element 110, an aperture 108, and a fiber optic face plate (e.g., a coherent fiber optic bundle) 112. In one embodiment, lens element 104 is a positive lens element with a convex surface 103 facing an object side of the assembly 102, and concave surface 105 facing an image side of the assembly 102. Lens element 104 is positioned closest to the object side of the assembly 102. In one embodiment, lens element 106 is a positive lens element with a convex surface 107 facing the object side of the assembly 102, and a convex surface 109 facing the image side of the assembly 102. Lens element 106 is positioned between lens elements 104 and 110, and lens element 110 is positioned closest to the image side of the assembly 102. In one embodiment, lens element 110 is a negative lens element with a concave surface 111 facing the object side of the assembly 102, and a convex surface 113 facing the image side of the assembly 102. In the illustrated embodiment, lens elements 106 and 110 are positioned directly adjacent to each other, with the convex surface 109 of lens element 106 conforming to and being in direct contact with the concave surface 111 of lens element 110. Thus, the lens elements are arranged in two groups, with the first group including lens element 104, and the second group including lens elements 106 and 110.

Fiber optic face plate 112 includes a non-planar (e.g., concave) front surface 115 facing the object side of the assembly 102, and a planar or substantially planar back surface 117 facing the image side of the assembly 102. Image sensor 114 includes a planar or substantially planar imaging surface 119 facing the object side of the assembly 102 and in contact with the surface 117 of the fiber optic face plate 112. Incident light from the object to be imaged is transmitted through the lens elements 104, 106, and 110, and is focused onto the non-planar surface 115 of the fiber optic face plate 112. The focused image is transmitted through the fiber optic face plate 112 and onto the surface 119 of the image sensor 114. In one embodiment, image sensor 114 is a Charge-Coupled Device (CCD) image sensor or Complimentary Metal-Oxide Semiconductor (CMOS) image sensor. In one embodiment, image sensor 114 is an APS-C size image sensor that generates digital representations of received images. In one embodiment, surfaces 103, 105, 107, 109, 111, 113, and 115 are all spherical surfaces. In another embodiment, one or more of surfaces 103, 105, 107, 109, 111, 113, and 115 are aspheric surfaces. In the illustrated embodiment, lens assembly 102 provides a 3.3 micrometer spot size at f/2, and has a 30 mm effective focal length, a 45 degree field of view, and a total axial length of 19.50631 mm.

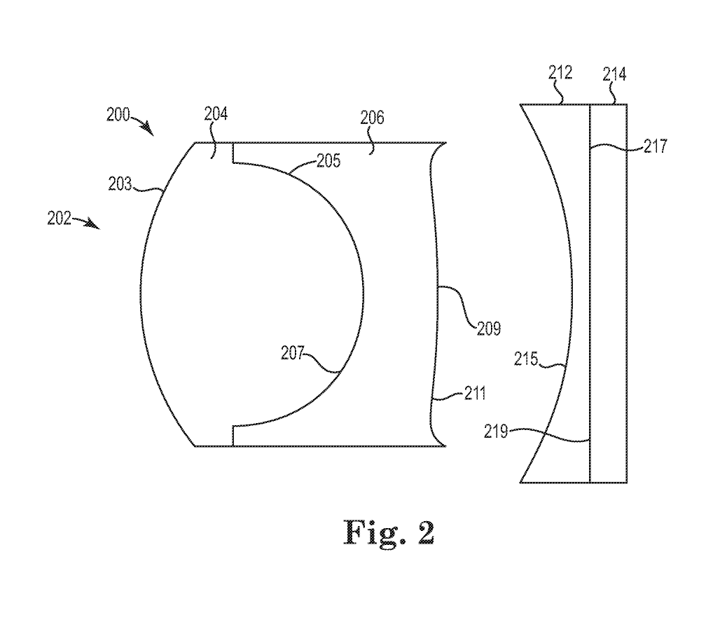

FIG. 2 is a diagram illustrating a lens and image sensor assembly 200 according to another embodiment. Assembly 200 includes a lens assembly 202 and an image sensor 214. Lens assembly 202 includes a first component lens element 204, a second component lens element 206, and a fiber optic face plate (e.g., a coherent fiber optic bundle) 212. In one embodiment, lens element 204 is a positive lens element with a convex surface 203 facing an object side of the assembly 202, and a convex surface 205 facing an image side of the assembly 202. Lens element 204 is positioned closest to the object side of the assembly 202. In one embodiment, lens element 206 is a negative lens element with a convex surface 207 facing the object side of the assembly 202, and a substantially concave surface 211 facing the image side of the assembly 202. Surface 211 includes a center portion 209 that protrudes outward toward the image side of the assembly 202. Lens element 206 is positioned closest to the image side of the assembly 202. In the illustrated embodiment, lens elements 204 and 206 are positioned directly adjacent to each other, with the convex surface 205 of lens element 204 conforming to and being in direct contact with the concave surface 207 of lens element 206. The lens elements 204 and 206 are arranged in a single group.

Fiber optic face plate 212 includes a non-planar (e.g., concave) front surface 215 facing the object side of the assembly 202, and a planar or substantially planar back surface 217 facing the image side of the assembly 202. Image sensor 214 includes a planar or substantially planar imaging surface 219 facing the object side of the assembly 202 and in contact with the surface 217 of the fiber optic face plate 212. Incident light from the object to be imaged is transmitted through the lens elements 204 and 206, and is focused onto the non-planar surface 215 of the fiber optic face plate 212. The focused image is transmitted through the fiber optic face plate 212 and onto the surface 219 of the image sensor 214. In one embodiment, image sensor 214 is a Charge-Coupled Device (CCD) image sensor or Complimentary Metal-Oxide Semiconductor (CMOS) image sensor. In one embodiment, image sensor 214 is an APS-C size image sensor that generates digital representations of received images. In one embodiment, surfaces 203, 205, 207, and 215 are all spherical surfaces. In another embodiment, one or more of surfaces 203, 205, 207, and 215 are aspheric surfaces. In the illustrated embodiment, lens assembly 202 provides a 4 micrometer spot size at f/3.5, and has a 15 mm effective focal length, and a 45 degree field of view.

In assemblies 100 (FIG. 1) and 200 (FIG. 2), a coherent fiber optic bundle (e.g., face plate 112 or 212) is interposed between the lens elements and the imaging plane of an image sensor (e.g., 114 or 214). The surface of the bundle that faces the lens is ground in a non-planar shape (115 or 215) that reduces lens aberrations. In another embodiment, the fiber optic face plate is not used, and the image sensor (e.g., 114 or 214) is a curved image sensor that has a non-planar focal surface shape (115 or 215), such as a spherical concave surface shape or other non-planar shape. The non-planar focal surface shape (i.e., the shape 115 or 215 of the surface of the bundle that faces the lens, or the non-planar focal surface of a curved version of the image sensor 114 or 214) and the lens elements are simultaneously optimized to reduce lens aberrations and produce the sharpest possible image. This allows for higher sharpness lenses at lower f numbers. One embodiment is directed to an interchangeable lens system in which each lens contains not only the optical lens elements, but also the image sensor, permanently bonded to the back face of the coherent fiber optic bundle. The focal plane surface (115 or 215) according to one embodiment becomes an additional free parameter, which is not optimized in conventional lens designs. In one embodiment, conventional optimization techniques can be used to simultaneously optimize both the lens elements and the shape of the focal plane.

One embodiment is directed to a lens assembly, which includes a plurality of component lens elements, and a fiber optic face plate having back surface and a non-planar front surface. The plurality of component lens elements are configured to direct a focused image onto the non-planar front surface of the fiber optic face plate, and the fiber optic face plate is configured to transmit the focused image through the back surface.

In one embodiment, the plurality of component lens elements includes only first, second, and third component lens elements with the first component lens element positioned adjacent to an object side of the lens assembly, the second lens element positioned in between the first and the third component lens elements, and the third lens element positioned adjacent to an image side of the lens assembly. In one form of this embodiment, the first component lens element has a convex surface facing the object side of the lens assembly, and a concave surface facing the image side of the lens assembly. In another form of this embodiment, the second component lens element has a convex surface facing the object side of the lens assembly, and a convex surface facing the image side of the lens assembly. The third component lens element according to one embodiment has a concave surface facing the object side of the lens assembly, and a convex surface facing the image side of the lens assembly, and the second and third component lens elements are in contact with each other.

In another embodiment, the plurality of component lens elements includes only first and second component lens elements with the first component lens element positioned adjacent to an object side of the lens assembly, and the second lens element positioned adjacent to an image side of the lens assembly. In one form of this embodiment, the first component lens element has a convex surface facing the object side of the lens assembly, and a convex surface facing the image side of the lens assembly. The second component lens element according to one embodiment has a concave surface facing the object side of the lens assembly, and a substantially concave surface facing the image side of the lens assembly, and the first and second component lens elements are in contact with each other.

In one embodiment, the non-planar front surface of the fiber optic face plate is a concave surface, and the back surface of the fiber optic face plate is substantially planar. The non-planar front surface of the fiber optic face plate and surfaces of the component lens elements according to one embodiment are jointly designed to reduce lens aberrations. In one embodiment, the non-planar front surface of the fiber optic face plate and surfaces of the component lens elements are spherical surfaces. The fiber optic face plate according to one embodiment is configured to transmit the focused image through the back surface and onto an imaging surface of an image sensor.

Another embodiment is directed to a lens assembly, which includes a plurality of component lens elements, and an image sensor having a non-planar front surface. The plurality of component lens elements are configured to direct a focused image onto the non-planar front surface of the image sensor, and the non-planar front surface of the image sensor and surfaces of the component lens elements are jointly designed to reduce lens aberrations. In one embodiment, the non-planar front surface of the image sensor is a concave surface. The non-planar front surface of the image sensor and surfaces of the component lens elements according to one embodiment are spherical surfaces. In one embodiment, the plurality of component lens elements in the lens assembly includes less than four component lens elements. In other embodiments, four or more component lens elements may be used.

Yet another embodiment is directed to a lens and sensor assembly, which includes a plurality of component lens elements, an image sensor having an imaging surface, and a fiber optic face plate having a back surface and a non-planar front surface. The back surface of the fiber optic face plate is mounted on the imaging surface of the image sensor. The plurality of component lens elements are configured to direct a focused image onto the non-planar front surface of the fiber optic face plate, and the fiber optic face plate is configured to transmit the focused image through the back surface and onto the imaging surface of the image sensor.

The following Examples I-III provide lens prescription data for three lens assembly embodiments that incorporate the techniques described herein:

### EXAMPLE I

A triplet lens design for a curved sensor
f-number = 1.2; FOV = 45 degree; Focal length = 30 mm
Lens Description
Data

| | | | | | Semi- |
|---|---|---|---|---|---|
| # | Surf Type | Curvature | Thickness | Glass | Diameter |
| OBJ | STANDARD | 0.0000000 | Infinity | | 0.0000000 |
| 1 | STANDARD | 0.0925714 | 2.0224431 | LAH58 | 8.0000000 |
| 2 | STANDARD | 0.0497467 | 5.4154968 | | 8.0000000 |
| STO | STANDARD | 0.0000000 | 0.3000000 | | 2.8842173 |
| 4 | STANDARD | 0.0970153 | 3.1911290 | LAF2 | 4.5000000 |
| 5 | STANDARD | −0.2285922 | 5.5969278 | P-SF67 | 4.5000000 |
| 6 | STANDARD | −0.1024257 | 2.9803104 | | 6.0000000 |
| IMA | STANDARD | −0.1016775 | 0.0000000 | | 5.0000000 |

### EXAMPLE II

Another triplet lens design for a curved sensor
f-number = 2; FOV = 45 degree; Focal length = 30 mm
Lens Description
Data

| | | | | | Semi- |
|---|---|---|---|---|---|
| # | Surf Type | Curvature | Thickness | Glass | Diameter |
| OBJ | STANDARD | 0.0000000 | Infinity | | 0.0000000 |
| 1 | STANDARD | 0.0925714 | 2.0224431 | LAH58 | 8.0000000 |
| 2 | STANDARD | 0.0497467 | 5.4154968 | | 8.0000000 |
| 3 | STANDARD | 0.0000000 | 0.3000000 | | 2.8842173 |
| STO | STANDARD | 0.0970153 | 3.1911290 | LAF2 | 4.5000000 |
| 5 | STANDARD | −0.2285922 | 5.5969278 | P-SF67 | 4.5000000 |
| 6 | STANDARD | −0.1024257 | 2.9803104 | | 6.0000000 |
| IMG | STANDARD | −0.1016775 | 0.0000000 | | 5.0000000 |

### EXAMPLE III

A doublet lens design for a curved sensor
f-number = 3.5; FOV = 45; Focal length = 15 mm
Lens Description
Data

| | | | | | Semi- |
|---|---|---|---|---|---|
| # | Surf Type | Curvature | Thickness | Glass | Diameter |
| OBJ | STANDARD | 0.0000000 | Infinity | | 0.0000000 |
| STO | STANDARD | 0.0000000 | 0.5172664 | | 2.1403115 |
| 2 | STANDARD | 0.0869580 | 14.7559370 | BEO | 8.2762616 |
| 3 | STANDARD | −0.2108830 | 5.3049314 | | 8.2762616 |
| 4 | STANDARD | −0.0648842 | 4.8188721 | | 8.2762616 |
| IMG | STANDARD | −0.0618212 | 0.0000000 | | 10.3453270 |

It is noted that these are merely example implementations, and are not intended to limit the scope of the present invention. Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A lens assembly, comprising:
a plurality of component lens elements;
an image sensor having a non-planar front surface; and
wherein the plurality of component lens elements are configured to direct a focused image onto the non-planar front surface of the image sensor, and wherein the non-planar front surface of the image sensor and surfaces of the component lens elements are jointly designed to reduce lens aberrations.

2. The lens assembly of claim 1, wherein the non-planar front surface of the image sensor is a concave surface.

3. The lens assembly of claim 1, wherein the non-planar front surface of the image sensor and surfaces of the component lens elements are spherical surfaces.

4. The lens assembly of claim 1, wherein the plurality of component lens elements in the lens assembly includes less than four component lens elements.

5. The lens assembly of claim 1, wherein the plurality of component lens elements includes only first, second, and third single-piece component lens elements.

6. The lens assembly of claim 5, wherein the first single-piece component lens element is a positive lens element and is positioned at an object side of the lens assembly, the second single-piece lens element is a positive lens element and is positioned between the first and the third component lens elements, and the third single-piece lens element is a negative lens element and is positioned at an image side of the lens assembly and between the second single-piece lens element and the fiber optic face plate.

7. The lens assembly of claim 6, wherein the second single-piece lens element has a convex surface facing the image side of the lens assembly that conforms to and is in surface contact with most of a concave surface of the third single-piece lens element.

8. A device, comprising:
a plurality of component lens elements;
an image sensor having a non-planar front surface; and
wherein the plurality of component lens elements are configured to direct a focused image onto the non-planar front surface of the image sensor, and wherein the non-planar front surface of the image sensor and surfaces of the component lens elements are simultaneously optimized to reduce lens aberrations.

9. The device of claim 8, wherein the non-planar front surface of the image sensor is a concave surface.

10. The device of claim 8, wherein the non-planar front surface of the image sensor and surfaces of the component lens elements are spherical surfaces.

11. The device of claim 8, wherein the plurality of component lens elements in the lens assembly includes less than four component lens elements.

12. The device of claim 8, wherein the plurality of component lens elements includes only first, second, and third single-piece component lens elements.

13. The device of claim 12, wherein the first single-piece component lens element is a positive lens element and is positioned at an object side of the lens assembly, the second single-piece lens element is a positive lens element and is positioned between the first and the third component lens elements, and the third single-piece lens element is a negative lens element and is positioned at an image side of the lens assembly and between the second single-piece lens element and the fiber optic face plate.

14. The device of claim 13, wherein the second single-piece lens element has a convex surface facing the image side of the lens assembly that conforms to and is in surface contact with most of a concave surface of the third single-piece lens element.

15. A method, comprising:
providing a plurality of component lens elements and an image sensor having a non-planar front surface, wherein the plurality of component lens elements are configured to direct a focused image onto the non-planar front surface of the image sensor; and
simultaneously optimizing surfaces of the lens elements and the non-planar front surface to reduce lens aberrations.

16. The method of claim 15, wherein the non-planar front surface of the image sensor is a concave surface.

17. The method of claim 15, wherein the non-planar front surface of the image sensor and surfaces of the component lens elements are spherical surfaces.

18. The method of claim 15, wherein the plurality of component lens elements in the lens assembly includes less than four component lens elements.
